(19) United States
(12) Patent Application Publication
(10) Pub. No.: US 2012/0205941 A1
(43) Pub. Date: Aug. 16, 2012

(54) SUN VISOR FOR AN AUTOMOBILE WINDOW

(76) Inventor: YUAN-CHUNG CHOU, Tainan (TW)

(21) Appl. No.: 13/026,298

(22) Filed: Feb. 14, 2011

(51) Int. Cl. B60J 1/20

(52) U.S. Cl. 296/152

(57) ABSTRACT

A sun visor for an automobile window is formed integrally and has a shape matching that of the upper edge of an automobile window frame. The sun visor has an upper edge and two sides formed with a smooth combining portion, a bulgy and arc-shaped screening portion formed to extend downward from a lower section of the combining portion, and a glue sheet adhered on an inner side of the combining portion. A decorative bar is installed on the outer side of the combining portion and has opposite ends respectively covered with a protective member that has an inner side formed with an engage groove for receiving each end of the decorative bar and an upper edge formed with a stop surface resisting against the top edge of both the decorative bar and the combining portion. The decorative bar functions to beautify the external look of the sun visor.

### BACKGROUND OF THE INVENTION

1. Field of the Invention

This invention relates to a sun visor for an automobile window, particularly to one able to achieve decorative effect and elevate whole external beauty.

2. Description of the Prior Art

Generally, for air circulation, the windows of an automobile are most probably moved downward to form gaps so that air inside and outside the automobile can carry out convection. However, when it is raining, rain will get into the automobile through the opened gaps of the windows and wet the persons in the automobile, or when an automobile is driven at high speeds, wind will blow into the automobile through the opened gaps and form strong wind pressure to rock the automobile and mess up a person's hair. Or if the sunlight is strong, the sunlight will shine into the automobile through the opened gaps. Therefore, an automobile is additionally installed with a sun visor on the upper edge of the outer side of a window. A conventional sun visor integrally made of acrylic material is directly glued on the frame edge of an automobile window for obstructing sunlight, rain and wind; nevertheless, the conventional sun visor for an automobile window does not have decorative effect in external look and hence appears extremely disharmonious.

### SUMMARY OF THE INVENTION

The objective of this invention is to offer a sun visor for an automobile window, having decorative effect for beautifying its external look.

The sun visor for an automobile window in the present invention, which is formed integrally and has a shape matching that of the upper edge of an automobile window frame, has its upper rim and two sides formed with a smooth combining portion, a bulgy and arc-shaped screening portion formed to extend downward from a lower section of the combining portion and a glue sheet adhered on an inner side of the combining portion.

The feature of this invention is that a decorative bar is provided on the outer side of the combining portion of the sun visor and has its opposite ends respectively covered with a protective member having an inner side formed with an engage groove for each end of the decorative bar to be engaged therein. The protective member has its upper edge formed with a stop surface for resisting against the top edge of both the decorative bar and the combining portion of the sun visor.

### BRIEF DESCRIPTION OF DRAWINGS

This invention will be better understood by referring to the accompanying drawings, wherein:

FIG. 1 is a perspective view of a sun visor for an automobile window in the present invention;

FIG. 2 is a partial magnified exploded perspective view of the sun visor for an automobile window in the present invention;

FIG. 3 is a cross-sectional view of the sun visor for an automobile window in the present invention; and

FIG. 4 is a perspective view of the sun visor for an automobile window in a using condition in the present invention.

### DETAILED DESCRIPTION OF THE PREFERRED EMBODIMENT

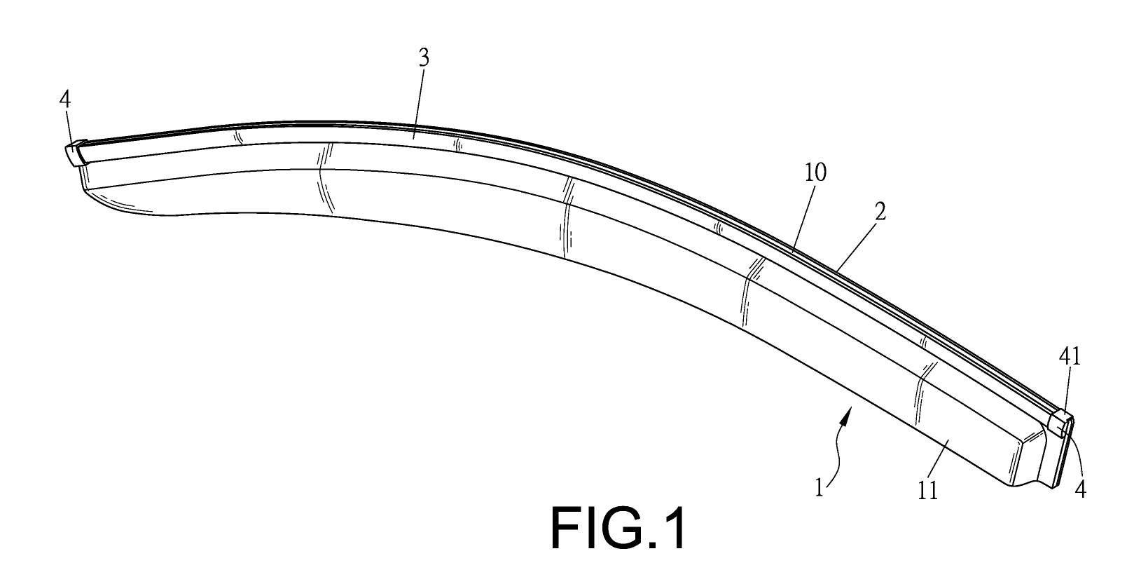

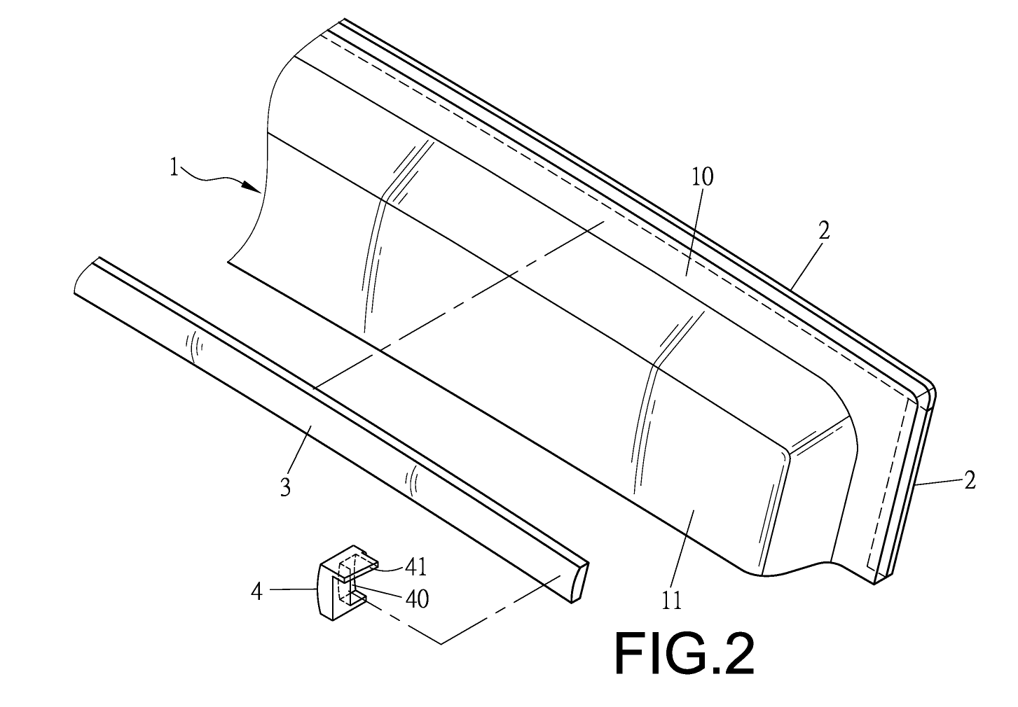

A preferred embodiment of a sun visor 1 for an automobile window in the present invention, as shown in FIGS. 1 and 2, is formed integrally and has a shape matching that of the upper rim of an automobile window frame. The sun visor 1 has an upper rim and two sides formed with a smooth combining portion 10, a bulgy and arc-shaped screening portion 11 formed to extend downward from a lower section of the combining portion 10, and a glue sheet 2 adhered on an inner side of the combining portion 10. A decorative bar 3 is installed on the outer side of the combining portion 10, having its opposite ends respectively covered with a protective member 4 that has its inner side formed with an engage groove 40 and its upper edge formed with a stop surface 41.

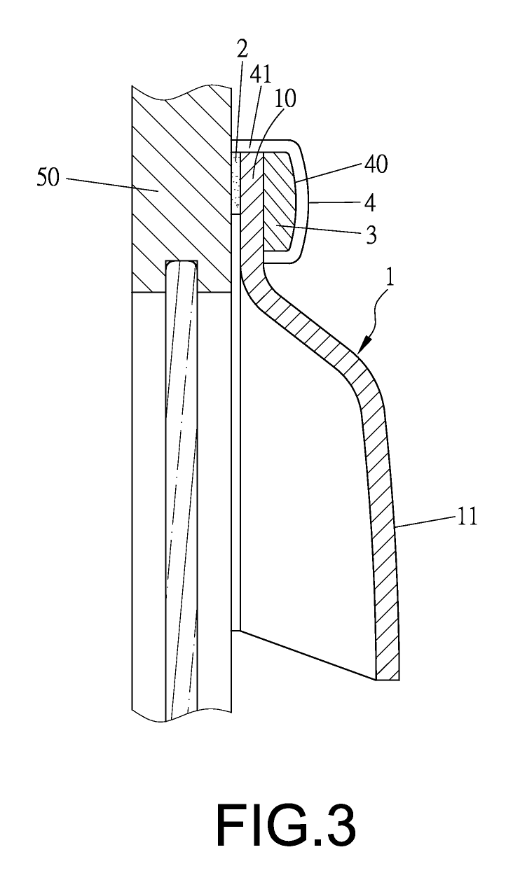

In assembling, referring to FIGS. 1, 2 and 3, firstly, the decorative bar 3 is firmly glued on the outer side of the combining portion 10 of the sun visor 1, and the two protective members 4 are respectively adhered to the opposite ends of the decorative bar 3 to have the two ends of the decorative bar 3 respectively engaged in the engage groove 40 of the two protective members 4. At this time, the stop surface 41 of the protective members 4 will resist on the stop edges of both the decorative bar 3 and the combining portion 10 1 to prevent the two ends of the decorative bar 3 from bending upward and produce decorative effect, thus finishing assembly of the sun visor for an automobile window.

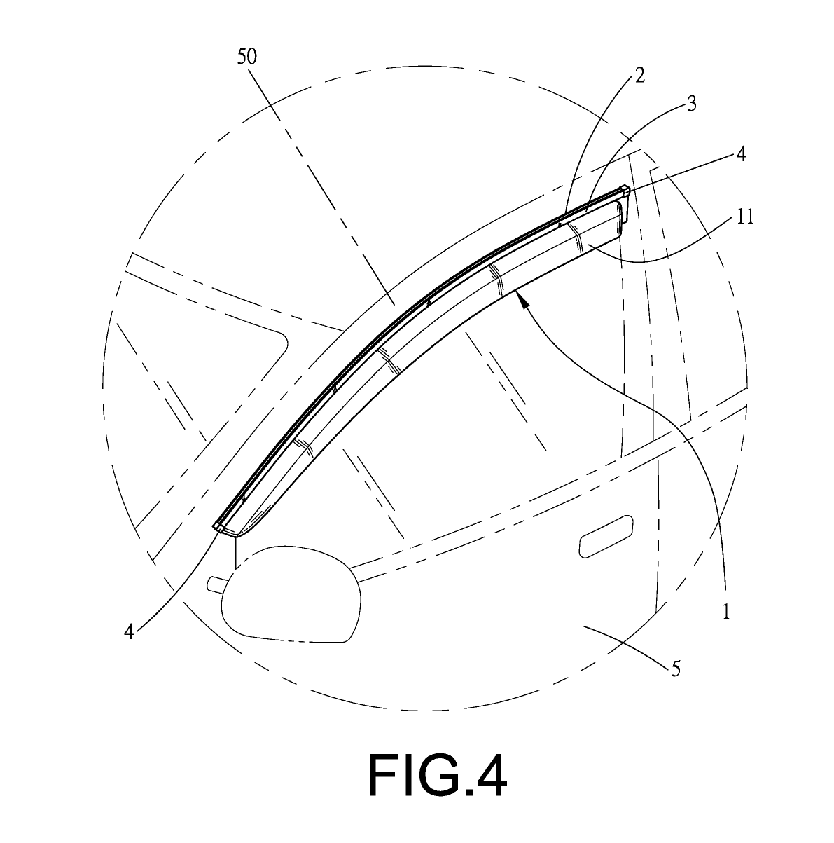

In using, referring to FIG. 4, the sun visor 1 has the inner side of the combining portion 10 firmly stuck to the upper edge 50 of the window frame of an automobile 5 by means of the glue sheet 2. Thus, when the automobile window is moved downward to form a gap, the screening portion 11 of the sun visor 1 will produce a marked effect, able to maintain air circulation inside the automobile during running of the automobile, no mater what the weather is, impossible to affect driving of the automobile. In addition, the decorative bar 3 provided on the upper edge of the combining portion 10 is able to beautify the external look of the sun visor 1, having decorative effect for elevating external appearance and matching the integral look of an automobile.

While the preferred embodiment of the invention has been described above, it will be recognized and understood that various modifications may be made therein and the appended claims are intended to cover all such modifications that may fall within the spirit and scope of the invention.

What is claimed is:

1. A sun visor for an automobile window formed integrally and having a shape matching that of an upper edge of an automobile window frame, said sun visor having an upper edge and two sides formed with a smooth combining portion, a bulgy and arc-shaped screening portion formed to extend downward from a lower section of said combining portion, a glue sheet adhered on an inner side of said combining portion, a decorative bar fixed on an outer side of said combining portion, said decorative bar having opposite ends covered with a protective member, said protective member having a engage groove in an inner side for each end of said decorative bar to fit therein closely and a stop surface formed on an upper edge, said stop surface resisting against top edges of both said decorative bar and said combining portion of said sun visor.
